(19) United States
(12) Patent Application Publication
(10) Pub. No.: US 2012/0176689 A1
(43) Pub. Date: Jul. 12, 2012

(54) OPTICAL VIEWER FOR COMPACT DISPLAYS

(76) Inventor: David Brown, Lahaina, HI (US)

(21) Appl. No.: 13/005,114

(22) Filed: Jan. 12, 2011

(51) Int. Cl. G02B 27/02; G02B 25/00; G02B 3/08

(52) U.S. Cl. 359/742

(57) ABSTRACT

An optical magnification device, configured to magnify the display of a videographic display device, may be constructed using a high-resolution Fresnel lens. The optical magnification device may be constructed to be foldable and able to be compactly stored/transported. Its construction may be configured to orient the lens above and generally parallel to a tray upon which a videographic display device may be positioned and or fastened for viewing through the lens.

### TECHNICAL FIELD

The present invention relates to compact electronic devices having videographic displays. More particularly, it relates to a portable viewer configured for providing a magnified view of a compact videographic display.

### BACKGROUND

Compact electronic devices including videographic displays have abounded over the past several years. Devices including hundreds of models of cellular phones, iPods™, iPhones™, Blackberry™ and Droid™ devices, e-book readers, and many more include videographic displays that often have small display areas (e.g., only about 6 to less than 15 square inches). Increasingly, many of these devices include software and/or other means for watching video content that may range from video shorts (e.g. seconds or minutes-long) to full length theatrical movies running over two hours long. An increasing number of such devices include a variety of text, text-plus-graphics, text-plus-video, and/or other content that includes material to be read and/or viewed for some other level of detail. For many people, and particularly for individuals who may be prone to eye strain/fatigue or who suffer from (corrected or uncorrected) visual impairments including such typical things as myopia, activities like reading, watching movies, or other extended viewing activities can be difficult on small screens.

It would be desirable to provide a portable optical magnifier device configured for use with compact electronic devices having a videographic display. Previous devices may not easily be portable and or may use lenses and/or magnification means that distort the images/text.

### BRIEF SUMMARY

In one aspect, embodiments of the present invention may include a compactable portable frame housing a magnifying Fresnel lens and configured with a support surface for a compact device including a video display. Certain preferred embodiments may readily be adjustable to accommodate different sizes and types of compact electronic devices, for which a magnified display is desired.

### BRIEF DESCRIPTION OF THE DRAWINGS

FIG. 1 shows an embodiment of an optical magnifying device;

FIGS. 2-4 show actuation and use of an optical magnifying device;

FIG. 5 shows another embodiment of an optical magnifying device, including audio amplification accessories; and

FIG. 6 shows a dual-lens embodiment of an optical magnifying device.

### DETAILED DESCRIPTION

Embodiments are described with reference to the drawings in which like elements are generally referred to by like numerals. The relationship and functioning of the various elements of the embodiments may better be understood by reference to the following detailed description. However, embodiments are not limited to those illustrated in the drawings. It should be understood that the drawings are not necessarily to scale, and in certain instances details may have been omitted that are not necessary for an understanding of embodiments of the present invention, such as—for example—conventional fabrication and assembly.

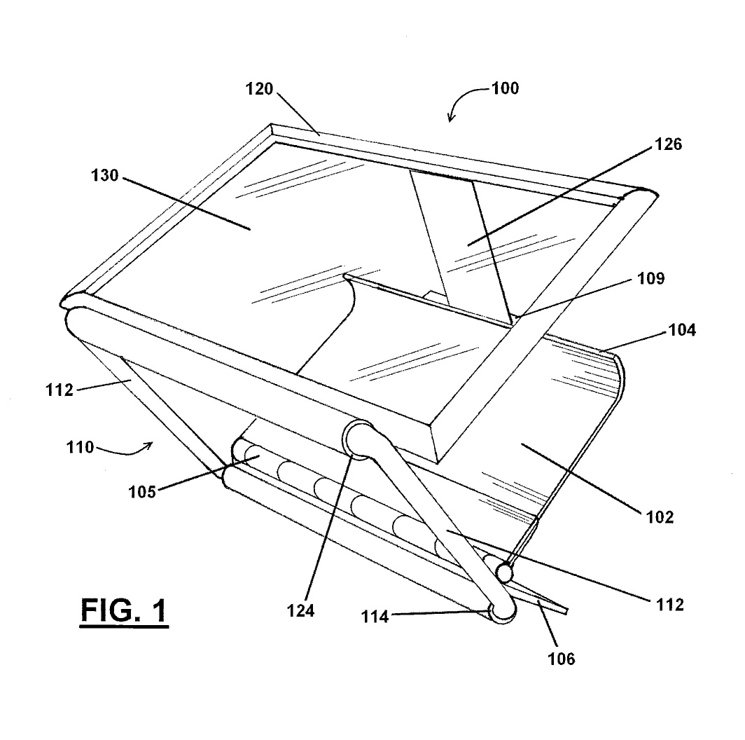

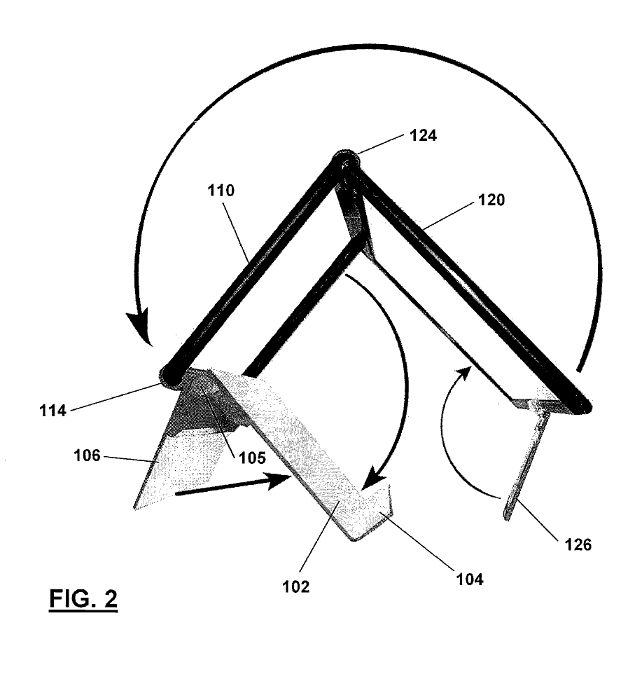

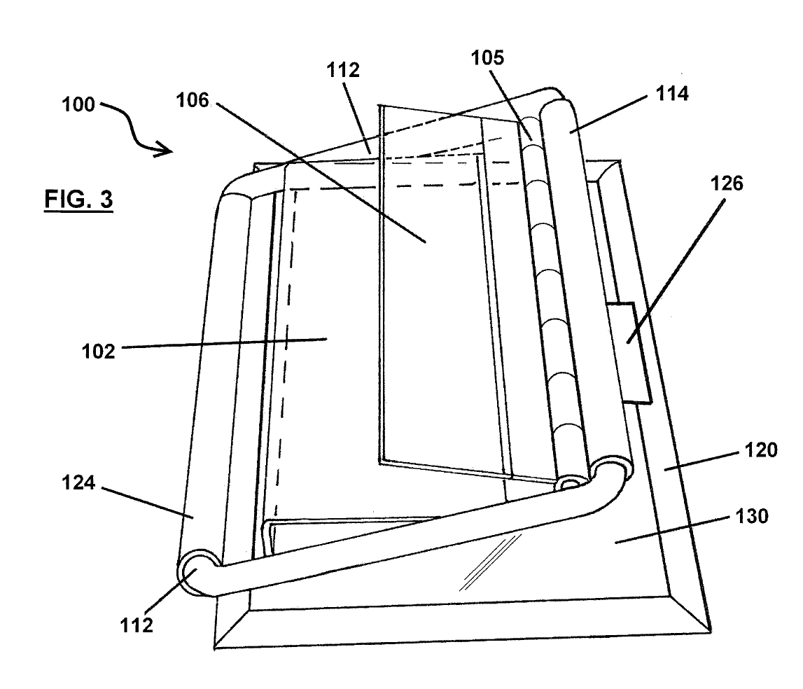

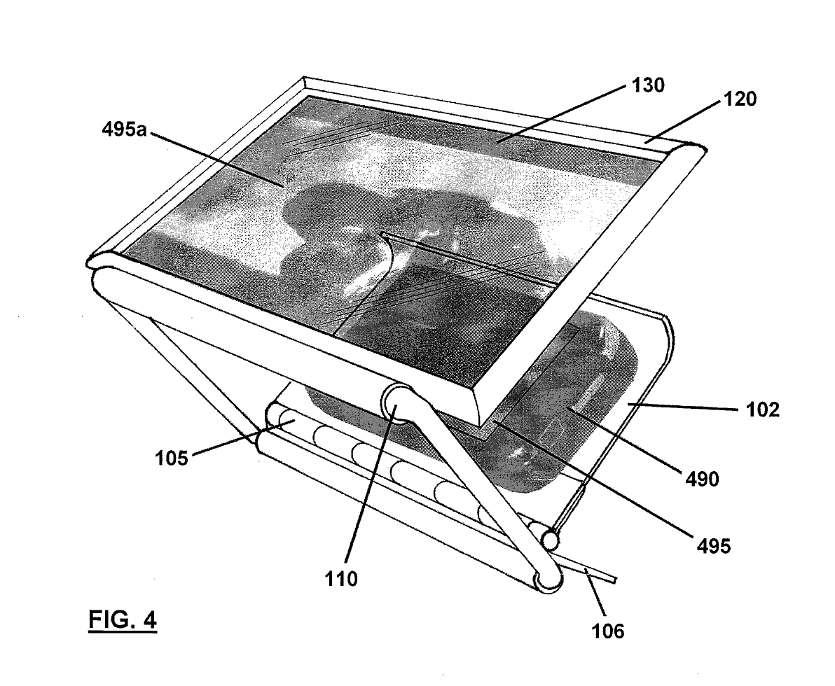

A first embodiment of an optical magnifying device 100 configured to magnify a compact videographic display is displayed with reference to FIGS. 1-4. FIG. 1 shows an embodiment of the device 100 in a deployed configuration; FIG. 2 shows a method of collapsing an embodiment of the device 100; FIG. 3 shows an embodiment of the device 100 in a nearly-collapsed configuration that—when fully collapsed—will be for transport/storage; and FIG. 4 shows an embodiment of the device 100 in a deployed configuration with a simulated image.

The device 100 includes a tray 102. The tray 102, which may be constructed of substantially transparent polycarbonate, may be configured as an easel tray including a lip 104 extending up from the upper tray face along one longitudinal edge. Along an edge opposite the lip 104, a lower support member 106 is hingedly/pivotably attached to the tray 102 along a lower support hinge 105. The lower support 106 is configured to fold out from the underside of the tray 102 to hold the tray at an angle relative to an underlying surface. Specifically, in one embodiment, the lower support hinge 105 may include an internal detent configured to releasably lock the lower support member 106 at a predetermined angle relative to the tray 102.

A lens support stand 110 is hingedly/pivotable mounted to the tray 102 along the same edge as the lower support 106. The lens support stand 110 includes a pair of rod members 112 connected to the tray 102 by a tray-stand hinge 114, which may be oriented substantially parallel with the lower support hinge 105. The tray-stand hinge 114 preferably will include at least one internal detent configured to releasably lock the lens support stand 110 at a predetermined angle relative to the tray 102. The predetermined angle may be, for example, about 90 degrees. The rod members may be constructed as telescoping in any of a variety of manners well-known in the art, which may provide the ability to focus the image in the lens when using different display devices.

A stand-frame hinge 124 connects an opposite end of the rod members 112 of the lens-support stand 110 to a frame 120. The stand-frame hinge 124 preferably will include at least one internal detent configured to releasably lock the lens support stand 110 at a predetermined angle relative to the frame 120 (e.g., at 90 degrees, or another desirable angle). The frame 120 is disposed about a high-resolution magnifying Fresnel lens 130. As shown in FIG. 1, the stand 110 and frame 120 are configured to support the lens 130 opposite and generally aligned with the tray 102. In many embodiments, the detents will hold the structural elements such that the lens 130 is generally or substantially parallel with the tray 102. It will generally be preferable to include a substantially to entirely transparent cover that is configured to be scratch-resistant, where the cover is disposed to protect the Fresnel lens from damage. In some embodiments, it will be preferable that the Fresnel lens be configured to provide a magnified image from a compact display, where the entire image is viewable on the lens and is magnified by at least 1.5× relative to the original display size. In some embodiments, the magnification may be as low as 1.25×, but in preferred embodiments, the magnification will be at least 1.5×, at least 2×, or at least 5×, and may be greater than 5×. The proportions of the lens may be constructed to provide height-width proportions for a specific device (e.g., a specific brand of media player, e-book reader, or the like), and/or may be constructed to provide a particular desired proportion height-width for viewing.

In embodiments where the detents and other elements are configured to support the lens 130 at a non-parallel orientation relative to the tray 102, it is preferable that the optical transmission of the lens 130 is calibrated, as well-known in the art, to provide a minimally distorted or substantially undistorted image from a videographic display upon the tray 102. In one exemplary embodiment, the magnification effect of the lens provides a similar visual perspective to that of a person watching a large-screen television from about 10 feet away, enabling a person to enjoy viewing an enlarged image from a small screen, even in compact quarters (e.g., an airline seat). Those of skill in the art will appreciate that one or more foldable, retractable, and/or removable shades or shrouds (not shown) may also be provided to help control ambient light between the tray 102 and the lens 130.

As shown in FIG. 1, a lens/frame support member 126 may also be provided. The lens/frame support member 126 may be configured to fold down and support the side of the lens frame 120 that is opposite the stand 110. A tray protrusion 109 may be provided to engage and/or support a lower end of the lens/frame support member 126. In certain embodiments, the lens/frame support member 126 may have about the same length/height as the stand 110, but—in other embodiments (e.g., as shown in FIGS. 2-3)—it may have a different length. The support member 126 may also improve the rigidity and stability of the device 100.

A method for collapsing or compacting the device 100 for transport/storage is shown with reference to FIG. 2. The lens/frame support member 126 may be folded up against the lens 130. The lens 130 (in its frame 120) may be rotated around/along the stand-frame hinge 124 to be substantially parallel with and/or co-planar to the rod members 112 of the stand 110. The stand 110 can be rotated around/along the tray-stand hinge 114 to fold the stand 110 and lens 130 down to fit near or even flush against the tray 102. The lower support member 106 can be folded up against the tray along the support-tray hinge 105.

In FIG. 3, the device 100 is shown as being folded nearly to a storage/transport configuration, which preferably will be rather compact. The rod members 112 of the stand 110 are be folded down along outer edges of the tray 102. The lens 130 in its frame 120 is shown as folded down along the stand-frame hinge 124 on its way to fit closely substantially parallel-oriented relative to the tray 102. The lower support member 106 may be folded up against the tray 102 along its hinge 105.

FIG. 4 shows the device 100 in a deployed configuration with a compact videographic display device 490 disposed on the tray 102. The videographic display device 490 is depicted as displaying an image 495 with a simulated magnified image 495a shown on the high-resolution Fresnel lens 130. The lens 130 is oriented apart from and generally parallel to the tray 102. The tray 102 may also include fastening means (not shown) such as, for example, hook-and-eye fasteners (e.g., Velcro™) slip-resistant silicone or other polymer member(s), clip(s), pegs(s), adhesive region(s), elastic strap(s), or any other appropriate fastening. The fastening means preferably are configured to hold a videographic display device securely upon the tray in a position providing optimal viewing through the lens.

### Example 1

One example of an optical display device, with dimensions that may be useful for certain applications, is described with reference to FIG. 1. In the exemplary embodiment, the height of the deployed device 100 from the tray end to the frame end of the stand's rod members 112 may be about 4 inches. The exterior dimensions of the frame 130, which is oriented parallel to the tray 102, are about 4.5 inches wide by about 6.5 inches long. The tray 102 is about 3 inches wide and about 5 inches long. The hinges 114, 124 are configured to hold the stand 110 perpendicular relative to both the tray and the frame 120.

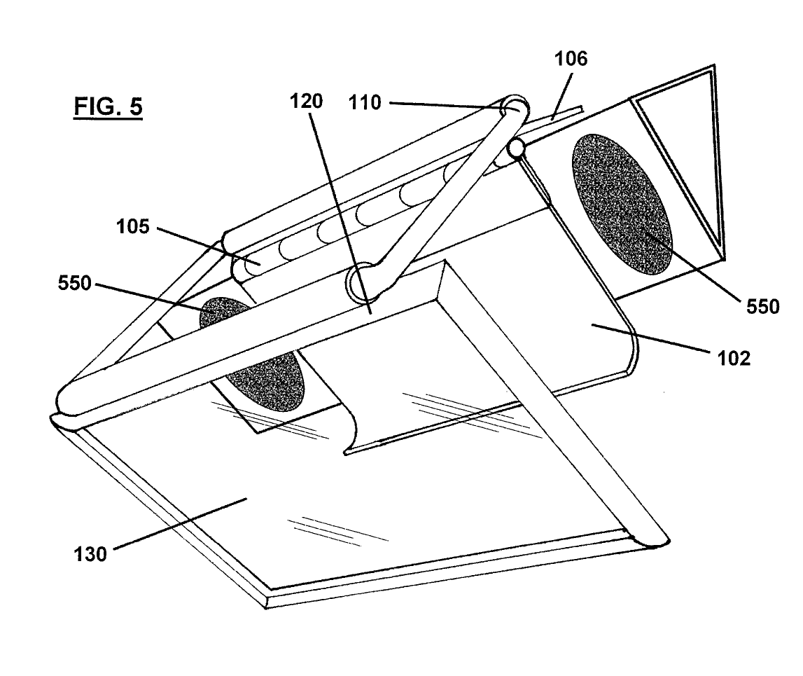

FIG. 5 shows another embodiment of the optical magnifying device 100, which includes a pair of audio speakers 550. The speakers 550 may be configured for wired or wireless connection to a device to be rested on the tray 102. Other embodiments may include only one speaker or more than two speakers. The speakers 550 preferably are configured to connect to and amplify sound from an electronic device (such as a videographic display device such as a compact media player, smartphone, etc.) positioned on the tray 102. The speakers may include internal amplifier means, or an external amplifier means may be included with the magnifying device 100.

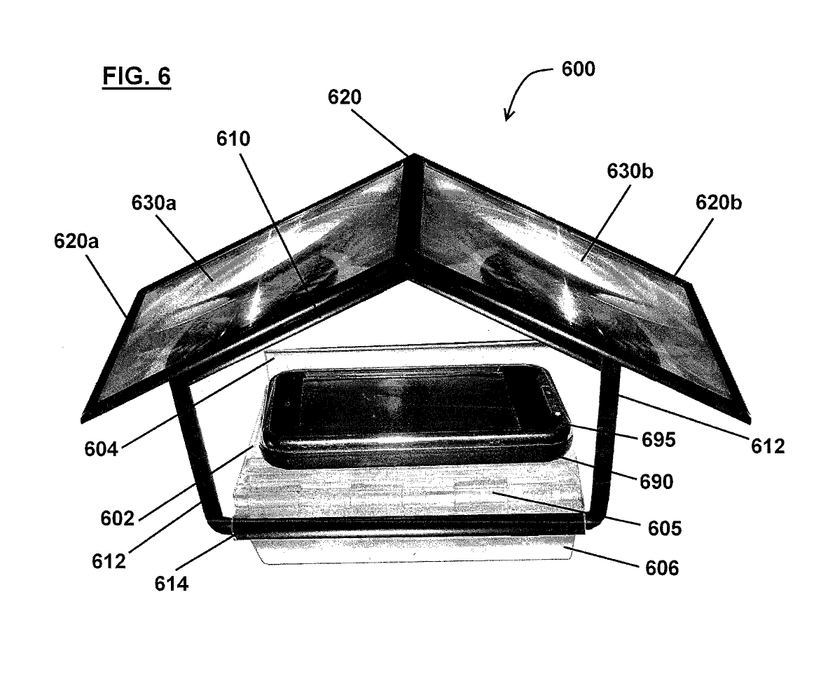

FIG. 6 shows an embodiment of an optical magnifying device 600, configured with two display lenses 630a, 630b. The device 600 includes a tray 602. The tray 602 may be configured as an easel tray including a lip 604 extending up from the upper tray face along one longitudinal edge. Along an edge opposite the lip 604, a lower support member 606 is hingedly/pivotably attached to the tray 602 along a lower support hinge 605. The lower support 606 is configured to fold out from the underside of the tray 602 to hold the tray at an angle relative to an underlying surface (e.g., by including an internal detent configured to releasably lock the lower support member 606 at a predetermined angle relative to the tray 602).

A lens support stand 610 is hingedly/pivotable mounted to the tray 602 along the same edge as the lower support 606. The lens support stand 610 includes a pair of rod members 612 connected to the tray 602 by a tray-stand hinge 614, which may be oriented substantially parallel with the lower support hinge 605. The tray-stand hinge 614 preferably will include at least one internal detent configured to releasably lock the lens support stand 610 at a predetermined angle relative to the tray 602. The predetermined angle may be, for example, about 90 degrees.

Two frame portions 620a, 620b of the double-frame 620 are attached to the stand 610 and are disposed to encompass about a pair of high-resolution Fresnel lenses 630a, 630b. As shown in FIG. 6, the stand 610 and frame 620 are configured to support the lens 630 opposite the tray 602. The double-frame 620 is configured to support the lenses 630a, 630b at an obtuse angle relative to each other, and oriented opposite and spaced apart from the tray 602 to magnify a videographic display oriented thereupon. Because the lenses 630a, 630b are disposed at a non-parallel orientation relative to the tray 602, it is preferable that the optical transmission of the lens 630a, 630b are calibrated, as well-known in the art, to provide a minimally distorted or substantially undistorted image from a videographic display of a compact electronic device (such as, for example, the device 690 having a videographic display 695) disposed upon the tray 602. Those of skill in the art will also appreciate that more than two lenses may be mounted in a display device of the present invention, so as to provide magnified viewing from a single device for two or more people.

Those of skill in the art will appreciate that embodiments not expressly illustrated herein may be practiced within the scope of the present invention, including that features described herein for different embodiments may be combined with each other and/or with currently-known or future-developed technologies while remaining within the scope of the claims presented here. Although specific terms are employed herein, they are used in a generic and descriptive sense only and not for purposes of limitation. It is therefore intended that the foregoing detailed description be regarded as illustrative rather than limiting. And, it should be understood that the following claims, including all equivalents, are intended to define the spirit and scope of this invention. Furthermore, the advantages described above are not necessarily the only advantages of the invention, and it is not necessarily expected that all of the described advantages will be achieved with every embodiment of the invention.

I claim:

1. An optical magnifying device configured to magnify a compact videographic display, the device comprising:
a tray configured to support an electronic device having a videographic display;
a hinged stand including a pair of rod members connecting ends of an elongate first hinge to ends of an elongate second hinge, where said first and second hinges are oriented substantially parallel to each other;
a first framed high-resolution Fresnel lens; and
a tray support member;
wherein the first hinge connects the hinged stand to the tray, and the second hinge connects the hinged stand to the first framed high-resolution Fresnel lens in a manner configured to support the lens opposite and generally aligned with the tray;
wherein the first hinge comprises a first hinge detent configured to releasably lock the hinged stand at a predetermined angle relative to the tray;
wherein the second hinge comprises a second hinge detent configured to releasably lock the first framed high-resolution Fresnel lens at a predetermined angle relative to the hinged stand; and
wherein the tray further comprises a third elongate hinge connecting the tray to the tray support member, where the third hinge is oriented substantially parallel with the first and second hinges, said third hinge comprising a third hinge detent configured to releasably lock the tray support member at a predetermined angle relative to the tray.

2. The device of claim 1, further comprising a lens support member attached to the first framed high-resolution Fresnel lens opposite the second hinge and configured to extend from the framed high-resolution Fresnel lens in generally the same direction as the hinged stand, wherein the lens support member is configured with a length configured to support the framed high-resolution Fresnel lens in an orientation generally parallel with the tray.

3. The device of claim 1, wherein the tray is constructed from generally transparent polycarbonate.

4. The device of claim 1, configured wherein the pair of rod members of the hinged stand and the first hinge are configured for movement such that in a storage/transport configuration, the rod members of the hinged stand are folded down along outer edges of the tray.

5. The device of claim 4, configured such that, in the storage/transport configuration, the first framed high-resolution Fresnel lens is folded along the along the second hinge to be closely and substantially parallel oriented relative to the tray.

6. The device of claim 1, wherein the tray further comprises fastening means configured to hold a videographic display device securely upon the tray.

7. The device of claim 1, wherein the first hinge detent, when engaged, supports the hinged stand at about 90 degrees relative to the tray.

8. The device of claim 1, wherein the second hinge detent, when engaged, supports the first framed high-resolution Fresnel lens at about 90 degrees relative to the hinged stand.

9. The device of claim 1, wherein the first and second hinge indents, when engaged, respectively support the hinged stand relative to the tray and the first framed high-resolution Fresnel lens relative to the hinged stand such that the lens is oriented spaced apart from and generally parallel to the tray.

10. The device of claim 1, further comprising a second framed high-resolution Fresnel lens adjacent the first framed high-resolution Fresnel lens and attached to the hinged stand by the second hinge, wherein both the first and second framed high-resolution Fresnel lenses are configured to be oriented opposite and spaced apart from the tray to magnify a videographic display oriented thereupon.

11. The device of claim 10, wherein the first and second framed high-resolution Fresnel lenses are oriented at an obtuse angle relative to each other, and the optical transmission of each is calibrated to minimize distortion of an image displayed near the tray.

12. The device of claim 1, further comprising at least one speaker configured to connect to and amplify sound from an electronic device positioned on the tray.

13. An optical magnifying device configured to magnify a compact videographic display, the device comprising:
an easel tray including a lip structure along a first longitudinal tray edge, the lip extending at an angle relative to an upper tray face, and the tray configured to support an electronic device having a videographic display;
an elongate support member hinge disposed adjacent a second longitudinal tray edge opposite the first longitudinal tray edge, the elongate support member hinge connecting a support member pivotably to the tray, where the support member is configured as extendable from a lower tray face to orient the tray at an angle relative to an underlying surface;
a pair of parallel rod members, a lower end of each of the rod members pivotably attached to and extending at about right angles from opposite longitudinal ends of the support member; and
a high-resolution Fresnel lens encompassed by a frame member, where the frame member is pivotably attached at about a right angle to an upper end of each of the rod members, and where the lens is orientable relative to the upper tray face to magnify a videographic display disposed thereupon.

14. The device of claim 13, wherein at least one rod member of the pair of parallel rod members is attached to the tray by a first hinge mechanism, and is attached to the frame member by a second hinge mechanism, said first hinge mechanism further comprising a first detent structure configured to releasably lock the at least one member at a predetermined angle relative to the tray.

15. The device of claim 13, wherein at least one rod member of the pair of parallel rod members is attached to the frame member by a second hinge mechanism, said second hinge mechanism further comprising a second detent structure configured to releasably lock the at least one member at a predetermined angle relative to the frame member.

16. The device of claim 15, wherein the predetermined angle is selected to orient the Fresnel lens substantially parallel with the upper face of the tray.

17. The device of claim 15, wherein the predetermined angle is about 90 degrees.

18. The device of claim 13, further comprising at least one speaker configured to connect to and amplify sound from an electronic device positioned on the tray.

19. The device of claim 13, further comprising a second high-resolution Fresnel lens encompassed by the frame member.

20. An optical magnifying device configured to magnify a compact videographic display, the device comprising:
an easel tray including a lip structure along a first longitudinal tray edge, the lip extending at an angle relative to an upper tray face, and the tray configured to support an electronic device having a videographic display;
an elevation frame hingedly attached to the easel tray; and
a framed high-resolution Fresnel lens hingedly attached to the elevation frame opposite the easel tray and configured to be oriented substantially parallel to and a predetermined distance away from the easel tray.
